(19) United States
(12) Patent Application Publication
(10) Pub. No.: US 2016/0062485 A1
(43) Pub. Date: Mar. 3, 2016

(54) ELECTRONIC DEVICE

(71) Applicant: KYOCERA CORPORATION, Kyoto (JP)

(72) Inventor: Masayoshi KONDO, Kanagawa (JP)

(73) Assignee: KYOCERA CORPORATION, Kyoto (JP)

(21) Appl. No.: 14/774,546

(22) PCT Filed: Mar. 13, 2014
(86) PCT No.: PCT/JP2014/056768

§ 371 Date: Sep. 10, 2015

Related U.S. Application Data
(63) Continuation of application No. PCT/JP2014/056768, filed on Mar. 13, 2014.

(30) Foreign Application Priority Data
Mar. 14, 2013 (JP) 2013-051427

(51) Int. Cl. G06F 3/0346

(52) U.S. Cl. CPC G06F 3/0346

(57) ABSTRACT

An electronic device capable of performing display control based on bending is provided. The electronic device has a display, a detecting unit, and a controller. The controller has flexibility. The detecting unit is able to detect bending of the display. In a case where bending is detected by the detecting unit, the controller performs display control based on the bending.

### TECHNICAL FIELD

The present invention relates to an electronic device having a flexible display.

### BACKGROUND ART

In electronic devices, there is a type having a flexible display called electronic paper. That electronic device has, for example, a sensor stacked on the display and is configured such that the display and the sensor can be stored in the main body of the electronic device in a state, for example, where they has been wound (see Patent Literature 1).

### CITATION LIST

### Patent Literature

Patent Literature 1: Japanese Patent Application Laid-Open No. 2007-264923

### SUMMARY OF INVENTION

However, even if bending or the like is performed on the display, the electronic device disclosed in Patent Literature 1 does not perform display control in response to the bending.

An object of the present invention is to provide an electronic device capable of performing display control based on bending.

The present invention relates to an electronic device having a display, a detecting unit, and a controller. The controller has flexibility. The detecting unit is able to detect bending of the display. The detecting unit has flexibility. In a case where bending is detected by the detecting unit, the controller performs display control based on the bending.

In the above described electronic device, in a case where bending is detected by the detecting unit, the controller may cause the display to display in a display area according to the position of the bending.

In the above described electronic device, in a case where bending is detected by the detecting unit, the controller may cause the display to display a second image different from a first image displayed in the discharge unit at a time when detecting the detection of the bending by the detecting unit.

The above described electronic device may further include an imaging unit, and in a case where the imaging unit is active and where bending of the display is detected by the detecting unit, the controller may display images acquired by the imaging unit, in each of an one side area of the display with respect to the position of the bending and the other side area different from the one side with respect to the position of the bending.

In the above described electronic device, the detecting unit may be configured by at least one of bending sensors, a touch panel, and a piezoelectric sheet.

In the above described electronic device, the detecting unit may detect a bending amount and a bending position, and the controller performs display control according to the bending amount and the bending position.

The above described electronic device may further include a electronic device body that accommodates the display, the detecting unit and the controller, and the detecting unit detects bending of a portion of the display drawn from the electronic device body.

In the above described electronic device, at the display, a hinge portion may be provided, and the detecting unit is an angle detection sensor provided at the hinge portion.

In the above described electronic device, in a case where a predetermined page of an electronic file is displayed in the display, if bending of the display is detected by the detecting unit, according to the position of the bending, the controller may perform display control to display a page after the predetermined page or a page before the predetermined page.

In the above described electronic device, the controller may display a page after the predetermined page in a case where the position of the bending of the display is in the vicinity of one end of the display, and display a page before the predetermined page in a case where the position of the bending of the display is in the vicinity of the other end of the display, and the one end and the other end may depend on the type of the electronic file.

In the above described electronic device, in a case where it is detected that the display has been kept in a bent state for a predetermined time or that bending is a predetermined angle or more, the controller may perform an operation of turning over a plurality of pages once or a consecutive page-turning operation.

In the above described electronic device, in a case where a predetermined page of an electronic file is displayed in the display, if bending of the display is detected by the detecting unit, the controller may finish browsing of the electronic file.

In the above described electronic device, if it is detected by the detecting unit that bending of the display is a predetermined bending angle or more, the controller may notify a warning representing that there is a fear that the display may be damaged by the bending.

According to the present invention, it is possible to provide an electronic device capable of performing display control based on bending.

### BRIEF DESCRIPTION OF THE DRAWINGS

FIG. 1 is a view for explaining an embodiment of an electronic device of the present invention.

FIG. 2 is a view for explaining an example of display control.

FIG. 3 is a view for explaining the electronic device having a electronic device body.

FIG. 4 is a view for explaining another embodiment of the electronic device of the present invention.

### DETAILED DESCRIPTION OF PRESENT INVENTION

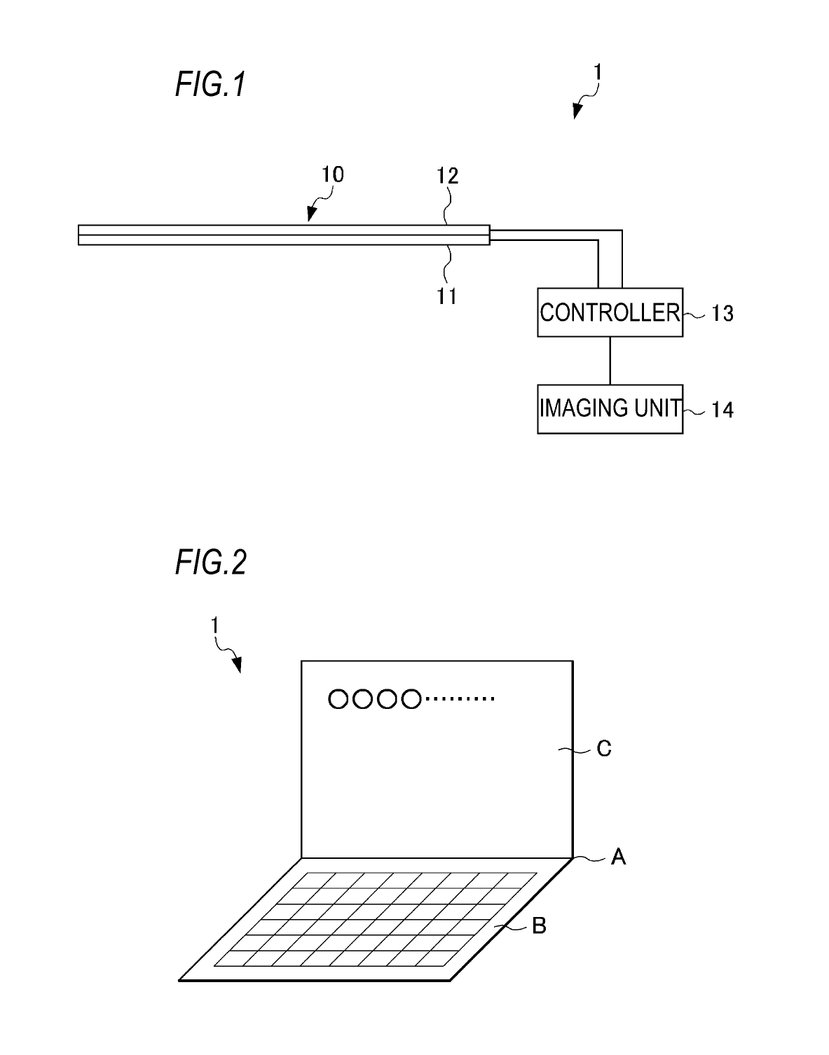

Hereinafter, an embodiment of an electronic device of the present invention will be described. FIG. 1 is a view for explaining an embodiment of the electronic device of the present invention.

As an example of an electronic device 1, electronic paper is taken.

The electronic device 1 has a display 11, a detecting unit 12, and a controller 13. The display 11 and the detecting unit 12 function as a touch panel display 10, for example.

The display 11 has flexibility. The display 11 is a flexible display, for example. As the display 11, for example, a liquid crystal panel, an organic EL (Electroluminescence) panel, or the like can be used.

The detecting unit 12 is disposed so as to overlap the display 11. The detecting unit 12 may be arranged so as to be in close contact with the display 11, or may be arranged so as to overlap the display 11 with a gel-like material (not shown) interposed therebetween. Incidentally, the detecting unit 12 may be arranged on the entire rear face of the display 11. Incidentally, the detecting unit 12 may be arranged on a part of the rear face of the display 11. The part of the rear face may be, for example, the vicinity of a transverse side or a longitudinal side on the rear face of the display 11. Incidentally, in the detecting unit 12, in a case where a gelatinous material is interposed between the detecting unit 12 and the display 11, it is possible to prevent the display 11 or the detecting unit 12 from being damaged due to excessive bending of the display 11 and the detecting unit 12.

Incidentally, inside the display 11, the detecting unit 12 may be configured.

The detecting unit 12 has flexibility. The detecting unit 12 is able to detect bending. The detecting unit 12 detects a bending amount and a bending position. The detecting unit 12 is, for example, a touch panel. As a specific example, the detecting unit 12 is a resistive or electrostatic touch panel. Otherwise, the detecting unit 12 may be configured by bending sensors. The bending sensors have, for example, a substantially linear shape, and a bending angle is detected according to the resistance values of the bending sensors. Here, in a case where the detecting unit 12 is bending sensors, the bending sensors may be arranged along the longitudinal sides and transverse sides of the display 11, respectively. Incidentally, the positions of the bending sensors are not limited to all of the transverse sides and longitudinal sides of the display 11, and may be one longitudinal side and one transverse side of the display 11. Incidentally, the bending sensors may be arranged respectively on the diagonal lines of the rear face of the display 11, and in this case, the detection results of the individual bending sensors are analyzed, whereby a bending amount and a bending position are comprehensively determined. Additionally, the detecting unit 12 may be, for example, a piezoelectric element (a piezoelectric sheet or a piezo film sheet). Here, the piezo film sheet may be a sheet made from plastic PVDF (PolyVinylidene DiFluoride) having a piezoelectric effect. In a case where the detecting unit 12 is a piezoelectric sheet, bending may be detected based on a voltage which is output in a case where the piezoelectric sheet is bent. The detecting unit 12 detects bending, for example, based on a change in resistance, voltage, or the like. In the detecting unit 12, in order to distinguish a normal touch operation from bending, for example, a threshold value for a change in resistance, voltage, or the like which is caused by bending is set to be higher as compared to a threshold value for resistance, voltage, or the like corresponding to a touch operation. Additionally, in a case where bending and the bending position are kept for a predetermined time, the detecting unit 12 may detect bending.

In a case where bending is detected by the detecting unit 12, the controller 13 performs display control based on the bending. The controller 13 performs display control according to the bending amount and the bending position.

FIG. 2 is a view for explaining an example of the display control. For example, in a case where the display 11 is rectangular, if the detecting unit 12 detects bending at a position of 50% of the total length in the longitudinal direction (or transverse direction), from an end portion of the display 11 toward the longitudinal direction (or transverse direction), the controller 13 displays a keyboard in an one side area B with respect to the bending position A, and displays characters input based on operations on the keyboard, in the other side area C, as shown in FIG. 2. That is, the controller 13 displays an inputting means in the one side area B, and displays a result reflecting the inputting means in the other side area C. Incidentally, the controller 13 may display an image (or a video) in the one side area B and display an image (or a video) in the other side area C, and the contents of the individual images (or videos) may be different from each other. Incidentally, in a state where a first page of an electronic book file (an electronic file) is displayed over the entire display, if bending is detected at a position of 50% of the total length in the longitudinal direction (or transverse direction), from an end portion of the display 11 toward the longitudinal direction (or transverse direction), the controller 13 performs control such that the first page and a second page are displayed. Here, display of the first page and the second page means that the first page is displayed in the one side area B with respect to the bending position A and the second page is displayed in the other side area C. The second page may be a page after the first page, or a page before the first page.

Otherwise, for example, in a case where the display 11 is rectangular, if the detecting unit 12 detects bending at a position of 30% of the total length in the longitudinal direction (or transverse direction), from an end portion of the display 11 toward the longitudinal direction (or transverse direction), the controller 13 performs display for prompting activation of a predetermined application, in the display 11. For example, the controller 13 displays the Explorer bar in the display 11.

Otherwise, for example, in a case where the display 11 is rectangular, if the detecting unit 12 detects bending at a position of 20% of the total length in the longitudinal direction (or transverse direction), from an end portion of the display 11 toward the longitudinal direction (or transverse direction), the controller 13 activates a predetermined application. For example, the controller 13 activates an audio player, and displays a music reproduction list in the display 11. Incidentally, the predetermined application may be an application lately activated from among applications activated before.

Otherwise, for example, in a case where the display 11 is rectangular, if the detecting unit 12 detects bending at a position of 10% of the total length in the longitudinal direction (or transverse direction), from an end portion of the display 11 toward the longitudinal direction (or transverse direction), the controller 13 displays information regarding status in the display 11. For example, the controller 13 displays a taskbar or a clock in the display 11.

Otherwise, for example, in a case where the display 11 is rectangular, if the detecting unit 12 detects bending in a direction oblique to the longitudinal direction (or transverse direction), a right-hand or left-hand keyboard is displayed in an one side area with respect to the bending position, and characters input based on operations on the keyboard are displayed in the other side area. Here, bending in a direction oblique to the longitudinal direction (or transverse direction) is bending in a direction which is not a direction parallel to the longitudinal direction (or transverse direction).

Otherwise, for example, in a case where the detecting unit 12 detects that the edge of the display 11 (for example, the vicinity of an end portion of the display 11) has been bent, the controller 13 performs any one of performing “Print Screen” on a screen which is currently displayed in the display 11 (saving the currently displayed screen as an image), performing control to put a bookmark in a case where a predetermined page of an electronic book file (an electronic file) is displayed in the display 11, displaying a mouse pad, activating a game, displaying a gadget for weather, stock prices, or the like in the display 11, and the like.

Otherwise, for example, in a case where the detecting unit 12 detects that the display 11 is turned over from the front face to the rear face, the controller 13 performs delaying a page displayed in the display 11 by a predetermined page of an electronic book file (an electronic file), displaying different screens between areas on respective sides of the display 11 with respect to the bending position, or the like. As cases of detecting that the display 11 is turned over, there are a case of detecting that the edge of the display 11 is bent from the rear face toward the front face, a case of detecting that it is bent in a direction substantially perpendicular to the display direction of the display 11, and so on. Incidentally, the front face indicates a surface of the display 11 where display is performed, and the rear face is a surface of the display 11 which is the back of the front face and where display is not performed.

Otherwise, for example, in a case where the detecting unit 12 detects bending based on slight shaking of the display 11, the controller 13 performs any one of erasing all of characters displayed in the display 11, returning to the previous screen, activating a game, and so on. Here, in a case where bending of the display 11 at a predetermined bending angle or less is consecutively detected at time intervals of a predetermined time or less, the detecting unit 12 or the controller 13 determines bending based on slight shaking.

Therefore, the electronic device 1 is able to perform display control based on bending. Additionally, in the above description, a case where the controller 13 performs various processes based on the bending position has been exemplified. However, the controller 13 may perform various processes as described above, based on the bending amount.

In a case where bending is detected by the detecting unit 12, it is preferable that the controller 13 controls the display 11 such that the display performs display in a display area according to the bending position.

For example, in a case where the display 11 and the detecting unit 12 are rectangular, if the detecting unit 12 detects bending at a position of 50% of the total length in the longitudinal direction (or transverse direction), from an end portion of the display 11 toward the longitudinal direction (or transverse direction), the controller 13 displays the same image or different image in each of areas on respective sides with respect to the bending position. Incidentally, the position of 50% is an example, and the present invention is not limited to this example.

Therefore, the electronic device 1 is able to perform display according to the bending position and is able to implement various display according to various bending.

In a case where bending is detected by the detecting unit 12, it is preferable that the controller 13 causes the display 11 to display a second image different from a first image displayed in the display 11 at a time when detecting the detection of the bending by the detecting unit 12.

For example, in a case where bending is detected by the detecting unit 12, the controller 13 activates an application and causes the display 11 to display an image (the second image) based on the application. Incidentally, the contents, size, and resolution of the image to be displayed may depend on the bending angle, the bending direction (the longitudinal direction, a transverse direction or an oblique direction), and the bending position.

The electronic device 1 may be a terminal which activates an electronic book application, or a terminal which displays electronic books (electronic files). In a case where a predetermined page of an electronic file is displayed, if bending of the display 11 is detected by the detecting unit 12, the controller 13 displays the next page or the previous page according to the bending position. Specifically, the controller 13 displays the next page in a case where bending is detected in the vicinity of one end of the display 11, and displays the previous page in a case where bending is detected in the vicinity of the other end of the display 11. Here, the positions of one end and the other end may depend on the type of the electronic file. For example, in a case where the electronic file is a right-hand file, one end may be the right end and the other end may be the left end. Incidentally, for example, in a case where the electronic file is a left-hand file, one end may be the left end and the other end may be the right end.

Incidentally, in a case where the display 11 is rectangular, according to which of the corners of the display 11 is the bending detection position, the next page or the previous page may be displayed. Incidentally, in a case where it is detected that the display has been kept in a bent state for a predetermined time or that bending is a predetermined bending angle or more, the controller 13 performs an operation of turning over a plurality of pages once, or a consecutive page-turning operation.

Otherwise, for example, in a case where an electronic book file (an electronic file) is displayed, if bending of the display 11 is detected by the detecting unit 12, the controller 13 performs a finishing process of browsing of the electronic book file (the electronic file). Specifically, in a case where the detecting unit 12 detects bending of the display 11 at a bending angle of 90 degrees or more, if a bending range wider than the bending range (for example, 10 degrees to 30 degrees) defined in page turning is detected or if bending of the display 11 is detected in the vicinity of the center (if so-called V-shaped bending is detected), the finishing process of browsing of the electronic book file (the electronic file) is performed. Incidentally, the finishing process of browsing of the electronic book file may be replaced with returning to the first page of the chapter of a currently displayed page.

Otherwise, for example, in a case where an image browsing application is activated, if bending is detected by the detecting unit 12, the controller 13 performs control such that images are transmitted one frame by one frame. That is, in a case where the image browsing application is activated and a first image is displayed in the display 11, if bending is detected by the detecting unit 12, the controller 13 transmits an image of one frame and causes the display 11 to display a second image.

Therefore, the electronic device 1 is able to perform display according to a bending operation of a user or the like.

Additionally, if it is detected by the detecting unit 12 that a bending angle is a predetermined value or more, the controller 13 notifies a warning representing that there is a fear that the display 11 may be damaged due to bending. As the notification manner, for example, a warning message may be displayed in the display 11.

It is preferable that the electronic device 1 further includes an imaging unit 14. The imaging unit 14 functions as a camera unit. The imaging unit 14 acquires still images or videos. The imaging unit 14 is built in the electronic device 1, or is externally attached to the electronic device 1. In a case where the imaging unit 14 is built in the electronic device 1, the imaging unit 14 may be arranged, for example, in a electronic device body 2 to be described below. Incidentally, in a case where the imaging unit 14 is externally attached, the electronic device 1 is provided with an interface (not shown) for connecting the imaging unit 14.

In this case, in a case where the imaging unit 14 is activated, if bending of the display 11 is detected by the detecting unit 12, the controller 13 displays images acquired by the imaging unit 14, in each of an one side area of the display 11 with respect to the bending position and the other side area different from the one side with respect to the bending position. Therefore, even in a case where the imaging unit 14 is arranged on one face side of the electronic device 1 and the display 11 is arranged on the other face side, if the display 11 is bent such that the other face faces the user side, even if the user is imaged by the imaging unit 14, the electronic device 1 enable the user to confirm the acquired image in real time. That is, the controller 13 is able to display a preview image in each of the one side area and the other side area.

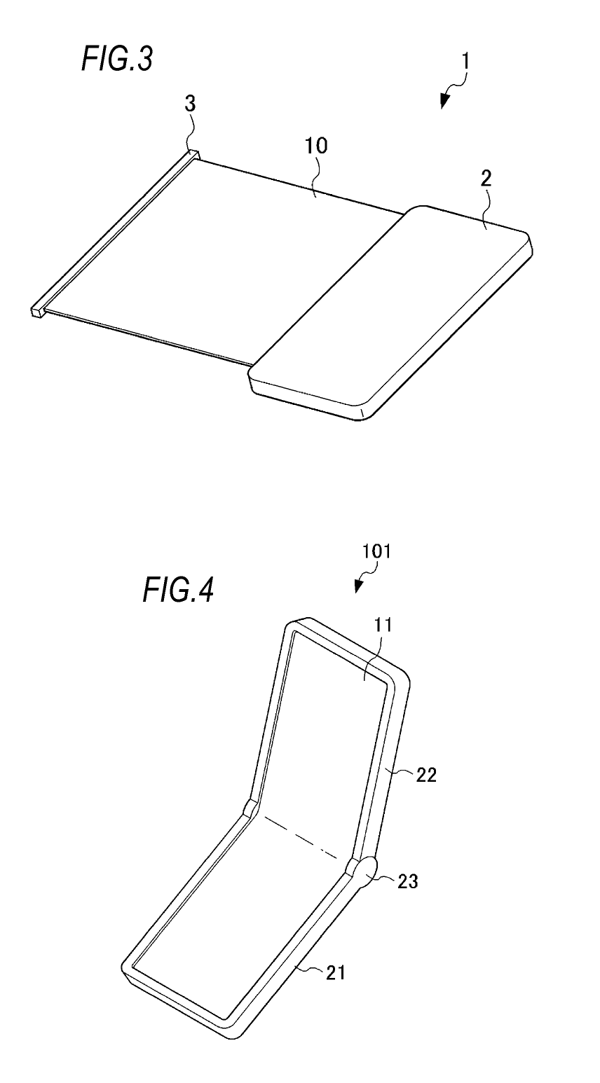

FIG. 3 is a view for explaining the electronic device 1 having the electronic device body 2.

It is preferable that the electronic device 1 further has the electronic device body 2 for accommodating the touch panel display 10 (the display 11 and the detecting unit 12) and the controller 13 as shown in FIG. 3. The electronic device body 2 winds up and stores the touch panel display 10. At one end of the touch panel display 10, a handle portion 3 is provided. The handle portion 3 is used to draw the touch panel display 10 from the electronic device body 2.

In this case, the detecting unit 12 detects bending of a portion of the touch panel display 10 (the display 11) drawn from the electronic device body 2. That is, the portion of the touch panel display 10 drawn from the electronic device body 2 is generally considered as being in a substantially planar shape. At the portion being in the substantially planar shape, the detecting unit 12 is not detecting the bending. Meanwhile, if the touch panel display 10 is wound and stored in the electronic device body 2, the detecting unit 12 detects bending at a plane area.

Therefore, in a case of newly detecting that it is bent at a portion where bending is not being detected by the detecting unit 12 (a portion where bending is not detected in a plane area), the controller 13 determines that there is bending and performs display control based on the bending.

As a result, the electronic device 1 is able to perform display control based on bending.

Additionally, on the assumption that a portion having been drawn from the electronic device body 2 in a case where the whole of the touch panel display 10 has not been drawn from the electronic device body 2 is 100%, if bending is detected at a position of 50%, 30%, 20%, or 10% of the drawn portion by the detecting unit 12, the controller 13 may perform display control corresponding to the bending position described above.

Here, as methods of keeping bending of the display 11 and the detecting unit 12, there are the following methods.

A first method is a method where a piezoelectric sheet is stacked on the rear side of the display 11. The rear side of the display 11 is a surface on the opposite side to a surface of the display 11 where the detecting unit 12 is arranged. At a bending portion of the display 11, resistance, a voltage value, or the like which is detected by the detecting unit 12 varies more significantly as compared to a case of a touch operation. Therefore, if a voltage is applied to the piezoelectric sheet such that a pressure is continuously applied to the bending portion, it becomes possible to keep the bending of the display 11. That is, it is possible to perform the example of the FIG. 2.

A second method is a method where a first magnet is provided on one end side of the display 11 and the detecting unit 12 and a second magnet is disposed such that the second magnet faces the first magnet. The polarities of the first magnet and the second magnet are the same. Therefore, one end side of the display 11 rises due to the repulsive force between the first magnet and the second magnet, and thus it becomes possible to keep the bending of the display 11. That is, it is possible to perform the example of the FIG. 2.

FIG. 4 is a view for explaining another embodiment of the electronic device of the present invention.

In the display 11, a hinge portion 23 may be provided. For example, the hinge portion 23 joins a first housing 21 and a second housing 22. In this case, the display 11 is arranged over the first housing 21, the hinge portion 23, and the second housing 22. In this case, the detecting unit 12 is an angle detection sensor (not shown) provided at the hinge portion 23. The detecting unit 12 measures an angle which the first housing 21 and the second housing 22 form with the hinge portion 23 interposed therebetween. The controller 13 performs display control based on the angle which is measured by the detecting unit 12.

Therefore, an electronic device 101 is able to perform display control based on bending even if having a configuration including the housings 21 and 22.

Although the present invention has been described in detail with reference to a specific embodiment, it is apparent to those skilled in the art that it is possible to add various changes or modifications.

This application is based on Japanese Patent Application No. 2013-051427 filed on Mar. 14, 2013 whose contents are incorporated herein by reference.

### DESCRIPTION OF REFERENCE NUMERALS AND SYMBOLS

1 ELECTRONIC DEVICE
11 DISPLAY
12 DETECTING UNIT
13 CONTROLLER
14 IMAGING UNIT
23 HINGE PORTION
101 ELECTRONIC DEVICE

1. An electronic device comprising:
a display, which has flexibility;
a detecting unit, which is able to detect bending of the display; and
a controller, which performs display control based on bending in a case where the bending is detected by the detecting unit.

2. The electronic device according to claim 1,
wherein, in a case where bending is detected by the detecting unit, the controller cause the display to display in a display area according to the position of the bending.

3. The electronic device according to claim 1,
wherein in a case where bending is detected by the detecting unit, the controller causes the display to display a second image different from a first image displayed in the discharge unit at a time when detecting the detection of the bending by the detecting unit.

4. The electronic device according to claim 1, further comprising:
an imaging unit,
wherein in a case where the imaging unit is activated, if bending of the display is detected by the detecting unit, the controller displays images acquired by the imaging unit, in each of an one side area of the display with respect to the position of the bending and the other side area different from the one side with respect to the position of the bending.

5. The electronic device according to claim 1, wherein the detecting unit is configured by at least one of bending sensors, a touch panel, and a piezoelectric sheet.

6. The electronic device according to claim 1,
wherein the detecting unit detects a bending amount and a bending position, and
wherein the controller performs display control according to the bending amount and the bending position.

7. The electronic device according to claim 1, further comprising:
a electronic device body that accommodates the display, the detecting unit, and the controller,
wherein the detecting unit detects bending of a portion of the display drawn from the electronic device body.

8. The electronic device according to claim 1,
wherein a hinge portion is provided at the display, and
wherein the detecting unit is an angle detection sensor provided at the hinge portion.

9. The electronic device according to claim 1,
wherein in a case where a predetermined page of an electronic file is displayed in the display, if bending of the display is detected by the detecting unit, according to the position of the bending, the controller performs display control to display a page after the predetermined page or a page before the predetermined page.

10. The electronic device according to claim 9,
wherein the controller displays a page after the predetermined page in a case where the position of the bending of the display is in the vicinity of one end of the display, and displays a page before the predetermined page in a case where the position of the bending of the display is in the vicinity of the other end of the display, and
wherein the one end and the other end depend on the type of the electronic file.

11. The electronic device according to claim 1,
wherein in a case where it is detected that the display has been kept in a bent state for a predetermined time or that the bending is a predetermined angle or more, the controller performs an operation of turning over a plurality of pages once or a consecutive page-turning operation.

12. The electronic device according to claim 1,
wherein in a case where a predetermined page of an electronic file is displayed in the display, if bending of the display is detected by the detecting unit, the controller finishes browsing of the electronic file.

13. The electronic device according to claim 1,
wherein if it is detected by the detecting unit that bending of the display is a predetermined bending angle or more, the controller notifies a warning representing that there is a fear that the display may be damaged by the bending.
